(19) United States
(12) Patent Application Publication
(10) Pub. No.: US 2009/0135930 A1
(43) Pub. Date: May 28, 2009

(54) METHOD FOR GENERATING A DELAY IN THE TRANSMISSION OF A MULTICARRIER SIGNAL, AND CORRESPONDING COMPUTER PROGRAM, STORAGE MEANS AND DEVICE

(75) Inventor: Stephane Lethimonier, Chevaigne (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: Teamcast, Saint-Gregoire Cedex (FR)

(21) Appl. No.: 12/274,048

(22) Filed: Nov. 19, 2008

(30) Foreign Application Priority Data
Nov. 23, 2007 (FR) 07/59246

(51) Int. Cl. H04L 27/00; H04L 27/28

(52) U.S. Cl. 375/260; 375/295

(57) ABSTRACT

A method is provided for generating a delay in the transmission of a multicarrier signal formed by a time-dependent series of symbols, in which the symbols include a set of complex time-dependent samples, in which each symbol includes a useful part and a guard time. The method includes the following steps: writing the samples forming the multicarrier signal in a memory; reading the memory with a variable latency corresponding to the delay; and modifying the variable latency by duplicating or suppressing at least one sample contained in a guard time.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of transmitting and broadcasting digital information by radiocommunication systems via signals using multicarrier modulations, for example signals carrying COFDM (Coded Orthogonal Frequency Division Multiplexing) modulations, hereinafter called COFDM signals.

More specifically, the disclosure relates to the application of a delay to a multicarrier signal (in its digital form) in the context of such a radiocommunication system.

The disclosure relates in particular but not exclusively to singe frequency networks (SFN), i.e. networks complying with the SFN protocol for digital transmission of television programs to mobile telephones.

### BACKGROUND OF THE DISCLOSURE

FIG. 1 shows a diagram of the establishment of a COFDM signal 100 (which is a multicarrier signal). The COFDM signal 100 includes a time-dependent series of COFDM symbols 101, 102, 103 (FIG. 1 shows the symbols n−1, n and n+1) with a duration TS.

Each COFDM symbol transports a certain number of encoded data and corresponds to a set of modulated sub-carriers of which the amplitudes and the phases are constant for the symbol duration.

Each COFDM symbol 102 includes two blocks:
a first block, called a guard time 1021, of which the content is dependent on the modulation standard;
a second block, called a useful part 1022, resulting from a modulation by inverse fast Fourier transform (IFFT) of the set of the sub-carriers described in the frequency domain. This IFFT has a size TU and, thus, the useful part 1022 has a duration TU.

At the intersection 104 of two symbols 102, 103, each sub-carrier potentially changes the amplitude and phase, characterised by amplitude and phase jumps. In the digital domain, each COFDM symbol is thus made up of a constant number of complex digital samples of which the duration (period) is the inverse of the processing frequency of the IFFT.

FIG. 2 shows the principle of operation of a COFDM receiver (or a COFDM signal receiver) by means of the signal 100 of FIG. 1.

The general principle of operation of a COFDM receiver is based on the successive analysis, by direct Fourier transform, of the various symbols 101, 102, 103 of the COFDM signal 100 received by the COFDM receiver.

An analysis window 201, 202, 203 of a duration TU (which duration TU is identical to the size of the IFFT used in the modulation) is therefore applied by the COFDM receiver on each COFDM symbol received so as to recover the amplitude and phase information of each of the sub-carriers and therefore the encoded data.

In a network complying with the SFN protocol implementing at least two devices transmitting the same COFDM signal intended for the same receiving device, it may be necessary to perform a compensation for a propagation time difference in the two COFDM signals so that they arrive synchronously at the receiving device. Indeed, one of the two signals may have a delay with respect to the other during its propagation, due, for example, to a longer propagation path.

The existing techniques for compensating for a propagation time difference in COFDM signals consist, for example, in the case of a modulation concerning a MPEG2-TS multiplex, of using a module for time-dependent synchronisation of the MPEG2-TS stream of the network, as explained in the document ETSI TS 101 191, in the context of the COFDM DVB-T modulation in SFN. With this solution, before the MPEG2-TS stream is distributed to the various modulators, periodic synchronisation information is added to it. This information consists of a “pointer”, which makes it possible to “decompose” the stream into a series of “Megaframes”, and a “time” of transmission of each of the “Megaframes”. This “time” is relative, with respect to a universal signal, which is 1 pps (1 pulse per second) provided by the GPS system. Each of the modulators processing this stream must therefore synchronise it using this “pointer” and “time” information, then verify this synchronisation once the method has started. In the case of an abnormality, the synchronisation must be redone, which causes the system to be restarted.

However, a disadvantage of these classic techniques is that the implementation of dynamic management of the compensation for the delay (in the time-dependent synchronisation module) in a COFDM signal produces significant disturbances of the COFDM signal which can make this signal, at the time of compensation, temporarily non-decodable by the receiver of this compensated COFDM signal.

### SUMMARY

According to a specific embodiment, an aspect of the disclosure relates to a method for generating a delay in the transmission of a multicarrier signal formed by a time-dependent series of symbols, in which said symbols consist of a set of complex time-dependent samples, in which each symbol includes a useful part and a guard time,

characterised in that it includes the following steps:
writing in a memory of the samples forming said multicarrier signal;
reading said memory with a variable latency corresponding to said delay;
modifying said variable latency by duplicating or suppressing at least one sample contained in a guard time.

The general principle of an exemplary embodiment is based on the generation of a variable delay on a multicarrier signal from a memory, in which said delay is made variable by suppressing or duplicating, in the memory, samples of a guard time of a symbol.

Thus, a dynamically variable delay is generated (by means of sample suppressions or duplications) on a multicarrier signal, which does not lead to significant degradations of the delayed multicarrier signal, due to the fact that the suppressed or duplicated sample(s) are contained in a guard time.

Preferably, the method includes the following steps implemented for each current sample of the signal:
writing of the current sample in the memory at a writing address indicated by a writing address counter;
reading of a previous sample, in which said previous sample has previously been written in the memory, at a reading address of which the value is equal to the value of the writing address at which a number of samples corresponding to said delay is reduced;
incrementation of the value of the writing address counter by 1.

Thus, this mechanism at the basis of the writing address counter and reading address generation makes it possible to simply, inexpensively and effectively generate a variable latency in the transmission of the multicarrier signal.

Preferably, said modification step is performed with a predetermined frequency.

Thus, the receiver(s) of the multicarrier signal is (are) allowed time to take into account these time-dependent modifications.

According to an advantageous feature of an example embodiment, said signal is of the COFDM type.

Preferably, the method for generating a delay is implemented in order to compensate for a dynamically variable delay undergone by said multicarrier signal.

Advantageously, the method for generating a delay is implemented in the context of the compensation for at least one variation in the propagation time of the multicarrier signal in a satellite channel of a hybrid Satellite/Terrestrial network for digital transmission of television programs to mobile terminals, in which the network is a single frequency network (SFN).

Thus, the method, according to at least one embodiment, makes it possible to compensate for a variation in the propagation time of a multicarrier signal in a radiocommunication network, in which said compensation is not performed at the level of a classic time-dependent synchronisation module.

Preferably, the method for generating a delay is implemented in a “network head modulator” of the hybrid network upstream of said satellite channel.

Advantageously, the method for generating a delay is implemented in each repeater of the hybrid network upstream of a terrestrial channel.

Preferably, the method for generating a delay is implemented at least twice in order to create a multi-path COFDM channel simulator with dynamically variable delays.

The disclosure also relates to a computer-readable storage medium optionally totally or partially removable, storing computer program comprising a set of instructions that can be executed by a computer in order to implement a method for generating a delay in the transmission of a multicarrier signal formed by a time-dependent series of symbols, in which said symbols consist of a set of complex time-dependent samples, in which each symbol includes a useful part and a guard time,

wherein said method includes the following steps:
writing in a memory of the samples forming said multicarrier signal;
reading said memory with a variable latency corresponding to said delay;
modifying said variable latency by duplicating or suppressing at least one sample contained in a guard time.

The disclosure also relates to a device for generating a delay including means for generating a delay in the transmission of a multicarrier signal formed by a time-dependent series of symbols, in which said symbols are made up of a set of complex time-dependent samples, with each symbol including a useful part and a guard time. This device includes:
means for writing in a memory of the samples forming said multicarrier signal;
means for reading said memory with a variable latency corresponding to said delay;
means for modifying said variable latency by duplicating or suppressing at least one sample contained in a guard time.

The advantages of the computer-readable storage medium and device for generating a delay are substantially the same as those of the method for generating a delay as mentioned above, and will not be described in further detail.

### BRIEF DESCRIPTION OF THE DRAWINGS

Other features and advantages will become clearer on reading the following description of an embodiment, given by way of a simple illustrative and non-limiting example, and appended drawings, in which:

FIG. 1 is a diagram showing the establishment of a COFDM signal 100;

FIG. 2 shows the principle of operation of a COFDM receiver (or COFDM signal receiver) by means of the COFDM signal of FIG. 1;

FIG. 3 shows the main steps of a specific embodiment according to the disclosure of the method for generating a delay R in the transmission of a COFDM signal;

FIG. 4 is a diagram of a hybrid Satellite/Terrestrial network for digital transmission of television programs to mobile terminals, the single frequency network (SFN), using a COFDM modulation according to a first specific application of the disclosure;

FIG. 5 shows a diagram of an implementation of a network head modulator of the network of FIG. 4 according to a specific embodiment of the disclosure.

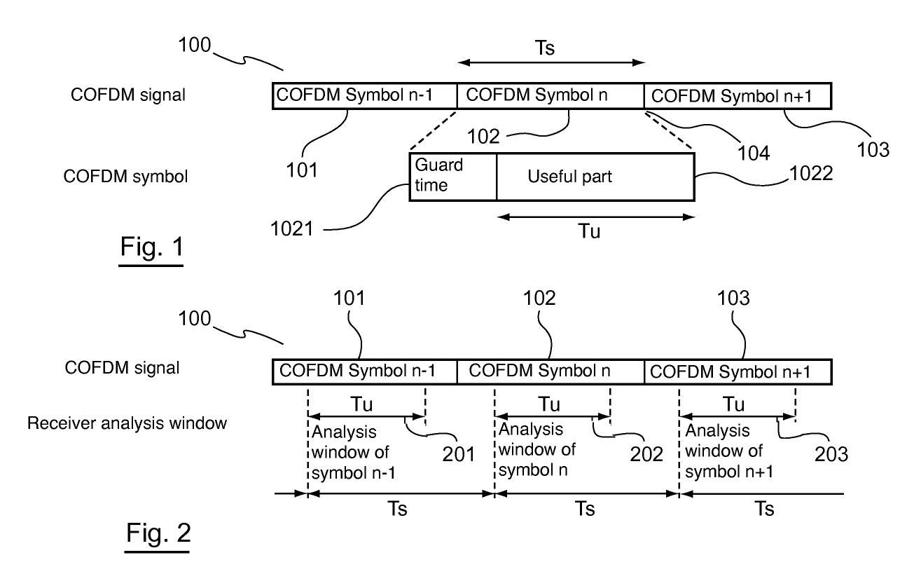

### DETAILED DESCRIPTION OF ILLUSTRATIVE EMBODIMENTS

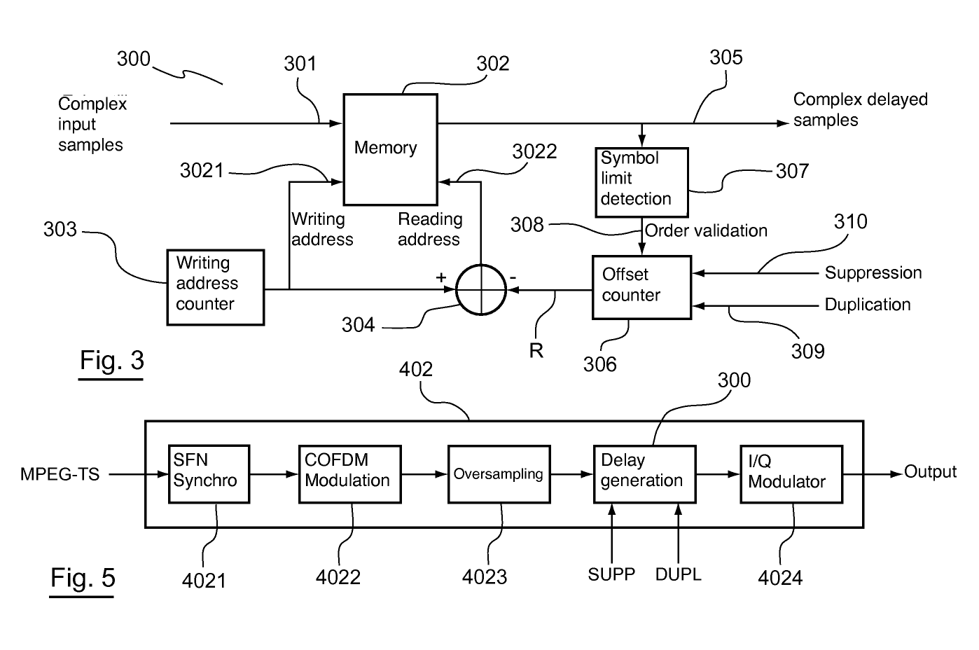

FIG. 3 shows the main steps of a specific embodiment according to the disclosure of the method for generating a delay R in the transmission of a COFDM signal, in which the method is implemented by a delay generation device 300.

The COFDM signal is formed by a time-dependent series of COFDM symbols, which symbols are formed by a set of complex time-dependent samples, and in which each symbol includes a useful part and a guard time.

The delay generation device 300 receives, at its input 301, the complex samples of the COFDM signal (which can be defined by their in-phase I and quadrature Q components).

For each current complex sample received by the delay generation device 300, this current complex sample received is written in a memory 302 (for example a buffer memory) so that it will be stored by said memory 302. This current sample is written at a writing address 3021 identified by a writing address counter 303.

During the writing of the current complex sample, a previous complex sample that has previously been written in the memory 302 is read at a reading address 3022 of which the value is equal to the value of the writing address at which the delay R (or latency) is reduced (by means of a subtractor 304). After reading, the preceding complex sample is delivered at an output 305 of the delay generation device 300. Then, the writing address counter is incremented before receiving a new complex sample.

Thus, the memory 302 is read with a latency (or delay), which is the delay that occurs between the writing and the reading of a single complex sample. The generation of addresses is performed according to a modulo corresponding to the size of the memory 302.

Consequently, the delay generation device 300 delays, by a delay R, the transmission of the COFDM signal, and thus forms a delay line.

The delay R is preferably equal to a multiple of the duration of a complex sample and is defined by a modification counter 306, which indicates by how many times the duration of a complex sample (forming the delay R) of the writing address 3021 must be reduced (by means of a subtractor 304) in order to obtain the reading address 3022.

The delay R can be modified (increased or reduced) dynamically. To do this, the modification counter 306 receives:
orders 309 for duplication of complex samples (which amounts to adding multiples of the duration of a complex sample to the delay R) if the delay must be increased, or
orders 310 to suppress complex samples (which amounts to cutting multiples of the duration of a complex sample from the delay R) if the delay R must be reduced.

In the modification of the delay R of the COFDM signal, it is preferable at the level of the delay generation device 300 to:
avoid modifying the content of the analysis window, and it is therefore preferable to perform modifications of the delay R at the level of the limits of the COFDM symbols (i.e. outside of the useful parts of these symbols);
limit the number of samples suppressed or duplicated so as not to excessively disturb the setting of the analysis windows;
limit the frequency of suppressions or duplications so as to leave time for the receiver to take into account these time-dependent modifications.

Preferably, the modifications are performed at a rate of one complex sample (or a fraction of a complex sample) at a time. An accumulator can be used if a plurality of complex samples must be suppressed or duplicated at one time.

A plurality of successive modifications of the duration of the delay R can be implemented at the level of the delay generation device 300. In this case, the frequency of these modifications is, for example, below 440 ns/s.

Preferably, in the case of the implementation of a modification of the duration of the delay R (by duplicating or suppressing complex samples at the level of the modification counter 306) during the writing of the current sample and the reading of the preceding sample, the method according to the disclosure includes a preliminary step of verifying that the preceding sample is not located in a useful part of a COFDM symbol, then the modification of the duration of the delay is implemented only if the verification is positive.

The step of verifying that the preceding sample is not located in the useful part of a COFDM symbol (which amounts to verifying that the sample is located substantially at the level of the border between two COFDM symbols) is implemented by a symbol limit detector 307, which is arranged at the output of the delay generation device 300, and which is supplied by the output 305.

Thus, in the case of a positive verification, the symbol limit detector 307 validates, by means of a validation signal 308, the orders to suppress or duplicate complex samples that are provided to the modification counter 306 and therefore authorises the implementation of the modification of the duration of the delay.

According to an alternative of this specific embodiment, the symbol limit detector 307 can also be implemented at the input of the delay generation device 300 on the condition that the validation signal 308 is subjected to the same delay as the complex samples for a single recognition by the modification counter 306.

The delay generation device 300 (or delay line) according to the disclosure can be implemented in the context of the creation of a delay on a COFDM signal, but also in the context of the dynamic compensation for variations in the propagation time of a COFDM signal due to the fact that this propagation time may be compensated dynamically by means of the delay generation device according to the disclosure.

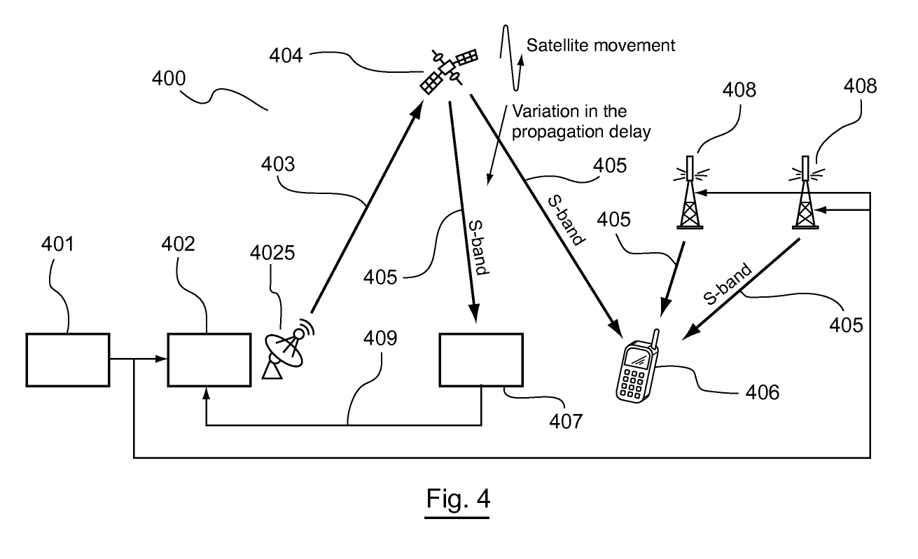

For example, as described below in relation to FIG. 4, a first specific application of the delay generation device 300 according to the disclosure is the compensation for variations in the propagation time of a COFDM signal in a satellite channel of a hybrid Satellite/Terrestrial network for digital transmission of television programs to mobile terminals, in which the network is a single frequency network (SFN) and uses a COFDM modulation.

FIG. 4 shows a diagram of a hybrid Satellite/Terrestrial network 400 for digital transmission of television programs to mobile terminals, the single frequency network (SFN), using a COFDM modulation according to a first specific application of the disclosure.

The network 400 includes a module 401 providing multiplexed television programs to a network head modulator 402 transmitting, by means of an antenna 4025, a Ka-band signal 403 representing multiplexed television programs, to a satellite 404. The satellite 404 receives the Ka-band signal 403 and transmits (after transposition of the Ka-band signal 403), in a satellite channel, a first S-band signal 405, to mobile terminals 406 on the ground.

In addition, classically, a second S-band signal 405′ is sent to the mobile terminals 406 via a terrestrial channel by terrestrial repeaters 408 (themselves connected to the module 401).

In the transmission system 400, all of the signals intended for a mobile terminal 406 must arrive at the mobile terminal 406 perfectly synchronised in time and frequency.

All of the modulators (network head modulator 402 and terrestrial repeaters 408) are configured according to the SFN protocol and therefore produce perfectly synchronous signals.

However, the Ka-band signal 403 from the network head modulator 402 is transmitted to the satellite 404, which is a geostationary satellite (which may be in inclined orbit or not), which transposes it into the first S-band signal 405 (in the satellite channel) and relays it to the mobile terminals 406.

However, in spite of its geostationary nature, the satellite 404 follows an orbit that distances it, then brings it closer to the earth on a cycle of around 24 hours. This variation in position of the satellite 404 with respect to the earth and therefore the mobile terminals 406 causes variability of the propagation time of the Ka-band signal 403 between the network head modulator 402 and the satellite 404 and the propagation time of the first S-band signal between the satellite 404 and the mobile terminals 406. The amplitude of these propagation time variations is such that the operation of the network 400 in a mode according to the SFN protocol is not possible without compensating for these variations in the propagation time.

Thus, in the context of this first application of the disclosure, in order to compensate for these variations in the propagation time of the Ka-band signal 403 and the first S-band signal 405 (which are COFDM signals), a measuring unit 407 is implemented, which receives the first S-band signal 405, and which measures the variations in the propagation time of said first S-band signal 405. This measuring unit 407 evaluates the time lag of the first S-band signal 405 coming from the satellite 404 with respect to the second S-band signal 405′ coming from the repeaters 408.

Then, the measuring unit 407 generates compensation orders (complex sample duplication or suppression orders) to compensate for the variations that it sends, via a link 409, to the modification counter 306 of the delay generation device 300, which is contained in the network head modulator 402, so that this device 300, by delaying or progressing the Ka-band signal 403, keeps these variations at a minimum value.

FIG. 5 shows a diagram of an implementation of the network head modulator 402 according to a specific embodiment of the disclosure.

The network head modulator 402 includes a synchronisation module 4021 according to the SFN protocol, which is supplied by the multiplexed television programs, for example, in MPEG-TS format. The synchronisation module 4021 transmits the multiplexed television programs once synchronised to a COFDM modulator 4022, which delivers a COFDM signal to an oversampling module 4023. The oversampling module 4023 delivers the oversampled COFDM signal (the signal is, for example, oversampled four times so as to reduce the duration of the complex sample, which oversampling does not degrade the signal and enables the post-processing to be performed: digital filtering, pre-distortion, etc.) to the delay generation device 300, which delivers the delayed COFDM signal to an I/Q modulator 4024. The I/Q modulator 4024 generates a baseband signal, which is then transposed into a Ka-band 403 (by means of a converter) so as to be transmitted by the antenna 4025.

Thus, the delay generation device 300 manages the suppression or the duplication of complex samples upon demand by the measuring unit 407.

It can be noted that, in the case of this implementation of the network head modulator 402, the role of the symbol limit detector 307 (which is arranged at the output of the delay generation device 300 and which is supplied by the output 305) cannot be adjusted by the COFDM modulator 4022 (by performing the step of verifying that the preceding sample is not located in a useful part of a COFDM symbol), but it can optionally directly deliver a signal indicating this limit (since it is the one that generates the OFDM signal). In this case, this signal must be propagated by the oversampling module 4023.

According to a first alternative of the first specific application of the disclosure shown in FIG. 4, instead of compensating for propagation time variations at the level of the network head modulator 402, a delay generation device 300 is implemented in each terrestrial repeater 408 so as to compensate for the variations in the propagation time of the Ka-band signal 403 and the first S-band signal 405, by adjusting the second S-band signal 405′ so that the first 405 and second 405′ S-0band signals are received in phase by the mobile terminals.

According to a second alternative of the first specific application of the disclosure shown in FIG. 4, which is particularly beneficial in the coverage of a large country (such as the United States) with a satellite in inclined orbit, a propagation time compensation is implemented:
not only at the level of the network head modulator 402 (compensation which is effective only in the case of a geographic zone near the measuring unit 407 due to the fact that a residual dynamic offset persists in the case of geographic zones far from this measuring unit 407),
but also in each terrestrial repeater 408, but with lower compensation amplitudes for these ones.

Below, we describe a real example of the first specific application of the disclosure described above in relation to FIG. 4.

In this example, the satellite 404 is in geostationary orbit at around 36,000 km from the earth and is subject to a variation in elevation of around one hundred kilometres. The required compensation characteristics for this real example are the following:
a maximum window of the time-dependent compensation: ±280 μs;
a maximum variation in the time-dependent compensation: 15 ns/s;
precision of the compensation: 1 μs.

In this example, the characteristics of the COFDM signal are the following:
modulation: DVB-SH;
channel width: 5 MHz;
system frequency: 5.71 MHz;
duration of a complex sample: 175 ns;
size of the IFFT: 2048 points;
guard time: ¼ (i.e. 512 points);
number of useful carriers: 1705;
duration of the useful part of the symbol (TU): 358 μs;
total duration of the symbol (TS): 448 μs.

In this example, measurements were taken to identify the limits of the compensations capable of being performed on the COFDM signal without significant degradation of the COFDM signal thus compensated. To verify that the compensated COFDM signal was not significantly degraded, we verified that the demodulation performance of a mobile television reception terminal (including a chip sold by the BiBcom company under reference DIB7000MCX) was not degraded by the time-dependent compensation.

We thus obtained a maximum size of the basic compensation jump of 22 ns (which corresponds to ⅛ of a complex sample) or 44 ns (which corresponds to ¼ of a complex sample) and a maximum frequency of the compensation of 440 ns/s. 44 ns corresponds to the period of the complex sample after oversampling of 4 (175 ns/4=43.8 ns). 22 ns corresponds to the period of the complex sample after oversampling of 8 (175 ns/8=21.9 ns).

Consequently, the recommended basic compensation jump size (22 ns or 44 ns) is not directly compatible with the COFDM signal used (due to the fact that the duration of a complex sample is 175 ns) and the maximum compensation frequency is well above what is necessary (15 ns/s).

According to a second specific application of the disclosure, it is possible to combine a plurality of delay generation devices according to the disclosure (or delay lines according to the disclosure) so as to produce a multi-path COFDM channel simulator with dynamically variable delays. In this application, the same complex OFDM signal supplies a plurality of branches each formed by a dynamically variable delay line (except possibly for the first) according to the disclosure (for example each produced in the form of the delay generation device 300 of FIG. 3) and an attenuator enabling adjustment of a gain. The outputs of the various branches are summed in order to generate the complex output signal. The complex system makes it possible to simulate a (fixed) multi-path channel (in which each of the paths has its own delay and its own attenuation).

At least one embodiment of the disclosure provides a technique for generating a dynamically variable delay on a multicarrier signal that does not lead to significant degradations in the delayed multicarrier signal.

In at least one embodiment, the technique is also intended to make it possible to compensate for a variation in the propagation time of a multicarrier signal in a radiocommunication network, in which said compensation is not performed at the level of a classic time-dependent synchronisation module.

In at least one of its embodiments, such a technique is simple and inexpensive to implement.

Although the present disclosure has been described with reference to one or more examples, workers skilled in the art will recognize that changes may be made in form and detail without departing from the scope of the disclosure and/or the appended claims.

What is claimed is:

1. Method for generating a delay in transmission of a multicarrier signal formed by a time-dependent series of symbols, in which said symbols comprise a set of complex time-dependent samples, in which each symbol includes a useful part and a guard time, wherein said method includes the following steps:
writing the samples forming said multicarrier signal in a memory;
reading said memory with a variable latency corresponding to said delay;
modifying said variable latency by duplicating or suppressing at least one sample contained in the guard time.

2. Method for generating a delay according to claim 1, wherein the method includes the following steps implemented for each current sample of the signal:
writing the current sample in the memory at a writing address indicated by a writing address counter;
reading a previous sample, in which said previous sample has previously been written in the memory, at a reading address of which the value is equal to a value of the writing address at which a number of samples corresponding to said delay is reduced;
incrementing the value of the writing address counter by 1.

3. Method for generating a delay according to claim 1, wherein said modification step is performed with a predetermined frequency.

4. Method for generating a delay according to claim 1, wherein said signal is a COFDM type signal.

5. Method for generating a delay according to claim 1, wherein the method is implemented in order to compensate for a dynamically variable delay undergone by said multicarrier signal.

6. Method for generating a delay according to claim 5, wherein the method is implemented in context of compensation for at least one variation in a propagation time of the multicarrier signal in a satellite channel of a hybrid Satellite/Terrestrial network for digital transmission of television programs to mobile terminals, in which the network is a single frequency network.

7. Method for generating a delay according to claim 6, wherein the method is implemented in a “network head modulator” of the hybrid network upstream of said satellite channel.

8. Method for generating a delay according to claim 6, wherein the method is implemented in each repeater of the hybrid network upstream of a terrestrial channel.

9. Method for generating a delay according to claim 1, wherein the method is implemented at least twice in order to create a multi-path COFDM channel simulator with dynamically variable delays.

10. A computer-readable storage medium comprising a set of instructions that can be executed by a computer in order to implement a method for generating a delay in transmission of a multicarrier signal formed by a time-dependent series of symbols, in which said symbols comprise a set of complex time-dependent samples, in which each symbol includes a useful part and a guard time, wherein said method includes the following steps:
writing the samples forming said multicarrier signal in a memory;
reading said memory with a variable latency corresponding to said delay;
modifying said variable latency by duplicating or suppressing at least one sample contained in the guard time.

11. Device for generating a delay, which comprises:
means for generating a delay in transmission of a multicarrier signal formed by a time-dependent series of symbols, in which said symbols are made up of a set of complex time-dependent samples, with each symbol including a useful part and a guard time;
means for writing the samples forming said multicarrier signal in a memory;
means for reading said memory with a variable latency;
means for modifying said variable latency by duplicating or suppressing at least one sample contained in the guard time.
